(19) United States
(12) Patent Application Publication
(10) Pub. No.: US 2014/0273551 A1
(43) Pub. Date: Sep. 18, 2014

(54) CABLE MODULE CONNECTOR ASSEMBLY SUITABLE FOR USE IN BLIND-MATE APPLICATIONS

(71) Applicant: Molex Incorporated, Lisle, IL (US)

(72) Inventors: Javier Resendez, Streamwood, IL (US); Frank T. Keyser, Elk Grove, IL (US); John Laurx, Aurora, IL (US)

(73) Assignee: Molex Incorporated, Lisle, IL (US)

(21) Appl. No.: 13/803,886

(22) Filed: Mar. 14, 2013

(51) Int. Cl. H01R 12/73; H01R 12/72

(52) U.S. Cl. CPC H01R 12/737; H01R 12/727
USPC 439/65

(57) ABSTRACT

A cable module that utilizes a plurality of multi-wire cables to provide connections between two sets of connectors is disclosed. The module has a first set of connectors intended to mate with mating connectors disposed on a mother board and a second set of connectors intended to mate with a plurality of opposing connectors disposed on a plurality of daughter boards. The mother board generally lies in the same plane as the base of the module, while the daughter boards are oriented generally transverse to the module base. The two sets of connectors are capable of limited movement in the horizontal and vertical directions to give the module assembly blind mate functionality. The second set of connectors is restricted from movement in the depth direction, while the first set of connectors is capable of such movement. An exterior actuating mechanism provides a mechanical advantage that reduces the effort required to advance the first set of connectors into mating engagement with their opposing counterparts on the mother board.

### BACKGROUND OF THE PRESENT DISCLOSURE

The Present Disclosure relates generally to high-insertion force connectors, and, more particularly, to high-insertion force connectors used within minimal space environments, such as blind mate environments.

In the current environment of high-speed data transmission, it is desirable to have high speeds and maximum density. Although this has been done before in terms of data transmission lines supported by circuit boards, it becomes problematic to run circuit board traces on a circuit board and not encounter impedance problems, noise, crosstalk and the like, especially at speeds exceeding 5 Gbs per second. The use of cables as a bypass to circuit board circuits has recently been adopted. However, each cable is usually terminated to a single connector. A cable with a large number of signal transmission wire pairs requires a connector with a large number of terminals to mate with an opposing connector. The use of pins as the connector terminals increases the force required to completely insert the connector into an opposing, mating terminal.

As each pin requires a certain amount of contact, or insertion force, a connector having a high density, i.e., a large number of pins/terminals, will require a high total insertion force as the individual force per in is multiplied by the total number of pins in a connector to obtain the overall connector insertion force. Large insertion force connectors are problematic to mate with opposing connectors in tight spaces where the connector mating is essentially a blind mating and room for leverage is hard to obtain. Moreover, the alignments between the opposing connectors may be slightly out of tolerance, thereby creating mating problems between the connectors. A need therefore exists for a high-density connector that is appropriate for blind mate applications and which has a low insertion force.

The Present Disclosure is therefore directed to an improved connector assembly for high-insertion force applications suitable for installation in confined spaces and for blind mate applications.

### SUMMARY OF THE PRESENT DISCLOSURE

Accordingly, there is provided a connector assembly with an improved structure suitable for blind mating high-insertion force applications. In accordance with an embodiment described in the following Present Disclosure, the connector assembly is incorporated into a cable module, the module having a plurality of cables extending between and terminated to opposing sets of connectors, and at least one of the sets of connectors being fixed together in a first line and the other set of connectors being arranged in a second line, angularly offset from the first line. The cable module may include a housing defining an interior space which houses a plurality of cables. These cables extend between two ends and each cable has a connector terminated to its respective ends. The cables typically include a plurality of wire pairs extending lengthwise through the cables. The wire pairs are terminated to terminals supported in two different connectors, disposed at respective, opposite ends of the cable. The terminals preferably take the form of conductive pins that engage opposing, mating receptacle terminals held in opposing connector housings.

Due to the nature of the terminals, each connector terminal of the cable module has a certain insertion force associated with it. Each connector of the cable module assembly preferably includes a rectangular or square array of such terminals. High-density connectors will contain more than 16 to 20 terminals in each connector housing. The total insertion force for such a connector is obtained by multiplying the single terminal insertion force by the number of terminals supported by a single connector. Consequently, the connector assemblies of the Present Disclosure require a large insertion force. However, an exterior actuator having a large mechanical advantage can be utilized in order to reduce the force required to operate the actuator and mate the connector assembly with opposing, mating connectors.

In the cable module assembly, one set of connectors are arranged along a first end of the module and are further maintained in a first line within a carrier disposed at the module first end. A set of second connectors is maintained in a second line angularly offset from the first line of connectors. The cables of the module are terminated to these first and second connectors. The cables each include at least one turn, or bend, in their extent between the first and second connectors to give the cables a desired amount of play so that they are flexible connections capable of movement that permit the first connectors to be advanced into mating contact with opposing connectors. This movement is accomplished by way of the exterior actuator.

The first connectors are fixed in the carrier and, in the first embodiment, the carrier is held within a slide housing mounted on two guide rails and capable of forward and backward movement at the front end of the cable module. The carrier is held by the slide housing in a manner that provides horizontal and vertical clearances so that the first connectors, in effect, “float” in place within the carrier and in the slide housing. This float will compensate for any misalignment of the connectors on the opposing circuit board. A cam mechanism is provided to advance and return the slide housing. The exterior actuator includes a lever disposed exterior of the cable module. The lever operatively engages an actuating shaft, or draw bar, captured on the cable module for linear movement in a direction transverse to the direction of mating. The draw bar includes a pair of engagement posts that project upwardly from it. The engagement posts act as cam followers captured within corresponding cam slots formed in the body portion of the slide housing. In this manner, actuation of the lever pulls the drawbar in one direction so that the engagement posts will ride along the cam slot surfaces from a first operative position to a second operative position along a non-linear path that has a general wide V-shape with two leg portions joined together at a junction. The draw bar is fixed in position on the cable module and, consequently, movement of the engagement posts urges the slide housing forward. As the slide housing moves forward, it moves the first connectors moves forwardly into engagement with an array of opposing, mating connectors.

The lever provides a mechanical advantage that easily overcomes the high insertion force due to the density of the connector terminals. The first connectors are is held in the carrier by means of a rib-track arrangement and fixed in place therein. The carrier is held by the slide housing in a manner that permits limited movement in the X and Y directions, i.e., horizontal (transverse) and vertical directions. Thus, the connector assembly of the Present Disclosure floats in its position and it is suitable for blind mate applications.

In a second embodiment described in the Present Disclosure, the actuator mechanism may include a linkage coupled to an exterior crank lever so that an installer need only turn the crank in one direction to engage the first connectors and turn it in the opposite direction to disengage the first connectors from their opposing connectors. The linkage includes three links, two of which are formed as a spaced apart pair on a hub which is fixed to the actuating shaft. A second, or connecting, link is pivotally connected at one end to the first links of the hub and at the other end, to the slide housing. The connecting links also have a generally wide V-shape with two leg portions joined together at an interior junction similar in shape to the cam slots of the first embodiment. The slide housing of both embodiments is supported by a pair of guide rails that serve to direct the forward/backward movement of the slide housing. The use of cables to interconnect the first and second connector sets of the cable module gives the assemblies of the Present Disclosure the ability to move under intended movement of the actuator and eliminates the need for a complex connection between the circuit board of the module and the connector sets.

These and other objects, features and advantages of the assemblies of the Present Disclosure will be clearly understood through a consideration of the following detailed description.

### BRIEF DESCRIPTION OF THE FIGURES

The organization and manner of the structure and operation of the Present Disclosure, together with further objects and advantages thereof, may best be understood by reference to the following Detailed Description, taken in connection with the accompanying Figures, wherein like reference numerals identify like elements, and in which:

FIG. 1 is a perspective view of a cable module assembly of the Present Disclosure, illustrating the general environment in which the cable module is utilized to provide a connection between a mother board and a plurality of daughter boards;

FIG. 2 is the same view as FIG. 1, but with the cover of the cable module and the side daughter boards removed for clarity;

FIG. 3A is the same view as FIG. 2, but with the daughter boards and actuating mechanism removed for clarity, and the connector set carrier and associated slide housing in an exploded fashion;

FIG. 3B is a view similar to that of FIG. 3A, but taken from the bottom side of the cable module illustrating the slide housing and connector carrier in an exploded fashion;

FIG. 4A is a perspective view of the cable module of FIG. 1, in confronting relationship with a mother board and a set of opposing, mating connectors thereon aligned with the cable module for mating;

FIG. 4B is the same view as FIG. 4A, but with the cable module aligned with the mother board connectors for eventual mating;

FIG. 4C is the same view as FIG. 4B, but with the first connectors of the cable module moved forwardly into engagement with the opposing connectors on the mother board;

FIG. 5A is a top plan view of the cable module of FIG. 1 in alignment with the mother board, similar to that shown in FIG. 4B;

FIG. 5B is the same view as FIG. 5A, but illustrating the actuator lever moved so that the cable module first connectors engage the mating connectors of the mother board;

FIG. 6 is an enlarged detail view of another style of actuating lever used to operate the slide housing of the cable module of FIG. 1;

FIG. 7 is a frontal view, partially exploded, illustrating a connector carrier of the Present Disclosure and its outer slide housing partially exploded for clarity;

FIG. 8 is an enlarged detail view of the connector carrier of FIG. 7, in place within the slide housing;

FIG. 9 is an enlarged detail view of the slide housing in place upon its associated guide rail and the alignment rod of the slide assembly;

FIG. 10 is a perspective view of a cable module incorporating an alternate embodiment of an actuating mechanism constructed in accordance with the principles of the Present Disclosure;

FIG. 11 is the same view as FIG. 10, but partially exploded to show the manner in which the first connectors are mounted within the connector carrier and the manner in which the connector carrier is mounted with the slide housing;

FIG. 11A is an enlarged detail view, partially exploded of one set of first connectors in place within a connector carrier and with the connector carrier shown in place within the slide housing of the cable module of FIG. 10;

FIG. 12A is an enlarged detail view of the cable module of FIG. 10 in opposition to and aligned with a mother board hosting a plurality of opposing, mating connectors;

FIG. 12B is the same view as FIG. 12A, but with the cable module connectors advanced as two units, into mating engagement with the connectors on the mother board;

FIG. 12C is an enlarged side elevational view of the cable module connector carrier, taken along Line C-C of FIG. 12A, illustrating the connector carrier and slide housing positioned in opposition to the mating connectors of the mother board; and

FIG. 12D is an enlarged side elevational view taken along Line D-D of FIG. 12B, illustrating the advancement of the slide housing and its associated connector carriers into mating engagement with the connectors of the mother board.

### DESCRIPTION OF THE PREFERRED EMBODIMENTS

While the Present Disclosure may be susceptible to embodiment in different forms, there is shown in the Figures, and will be described herein in detail, specific embodiments, with the understanding that the Present Disclosure is to be considered an exemplification of the principles of the Present Disclosure, and is not intended to limit the Present Disclosure to that as illustrated.

As such, references to a feature or aspect are intended to describe a feature or aspect of an example of the Present Disclosure, not to imply that every embodiment thereof must have the described feature or aspect. Furthermore, it should be noted that the description illustrates a number of features. While certain features have been combined together to illustrate potential system designs, those features may also be used in other combinations not expressly disclosed. Thus, the depicted combinations are not intended to be limiting, unless otherwise noted.

In the embodiments illustrated in the Figures, representations of directions such as up, down, left, right, front and rear, used for explaining the structure and movement of the various elements of the Present Disclosure, are not absolute, but relative. These representations are appropriate when the elements are in the position shown in the Figures. If the description of the position of the elements changes, however, these representations are to be changed accordingly.

FIG. 1 illustrates a cable module assembly 20 constructed in accordance with the principles of the Present Disclosure. The cable module 25 can be seen to have an overall rectangular shape with front and back ends 26, 27 and side edges 28, 29. The module 25 is intended to connect a plurality of daughter boards 30 to another circuit board 32, which typically is a mother board of an electronic assembly. The module is typically used in a tight, confined space, with the daughter boards 30 oriented at an angle to the circuit board 32. The cable module 25 is provided with a plurality of connectors that permit it to be connected to the daughter boards 30 and the mother board 32. In this regard, as best illustrated in FIG. 2, the cable module 25 includes a set of first connectors 35 arranged in a line along the front end 26 of the module 25 and a set of second connectors 37 arranged in a line along the side edge 28 of the module 25.

As shown, the daughter boards are perpendicular to the mother board and to the module 25 so that in installation, the module 25 must be inserted so that it engages both the daughter boards 30 and the mother board 32. Hence, one set of the connectors is relatively fixed in place on the module 25 and the other set is fixed in a carrier that is movable and which permits the first connectors 35 to be moved in and out of engagement with their opposing connectors 38. The second connectors 37 disposed along the side edge 28 of the module 2 engage like positioned connectors 40 disposed on individual daughter boards 30. The second connectors 37 are held in a manner such that they have limited movement in the horizontal and vertical directions, respectively “X” & “Y” directions as illustrated in FIG. 1. The cable module 25 must be mated to two different sets of connectors that extend in two different, intersecting planes and as such, one set of the cable module connectors must be capable of movement into and out of engagement with their opposing, mating connectors.

The first connectors 35 are disposed along the front edge 26 of the module 25 and are intended to mate with a plurality of opposing, mating connectors 38 fixed in their position on the mother board 32. Accordingly, the first connectors 35 are held in a manner that permits slight movement horizontally and vertically but are held in place with respect to the depth direction, “Z” shown in FIG. 2. They are held within a connector carrier 50 that is held by the moveable slide housing 78 in a manner that permits the first set of connectors to be moved forward and backward relative to the module 25 to engage and disengage the connectors 38 on the mother board 32.

The connector carrier 50 is formed from a top half 52 and a bottom half 51. The carrier 50 is rectangular so that it may hold a rectangular array of connectors 35 as shown. The carrier halves 51, 52 include channels, or tracks 54, formed along their inner, horizontal surfaces which receive opposing, projecting ribs 56 that are formed on the sidewalls 59 of the first connectors 35. The first connectors 35 include insulative housings 55 that support an array of conductive terminals 57. This type of connector 35 may be of the pin header style where a connector base 58 is flanked by a pair of sidewalls 59. The ribs 56 project out from the sidewalls 59 and are held in the carrier channels 54. The carrier 50 thereby serves to hold the many connectors 35 together as a unit or units.

Importantly and in order to accommodate the moveable attachment aspect of the first connectors 35, multi-wire cables 44 are used to connect respective associated pairs of the first and second connectors 35, 37 together. The cables 44 are held in an interior space 60 that is defined between the opposing cover and base plates 42, 43 respectively. The wires contained within the cables 44 are terminated to tail portions of the connector terminals 57 and the terminal contact portions project through the connector housing 36 and are arranged in a pattern between the sidewalls 59 thereof, most often in a rectangular array of distinct rows and columns. The cables 44 extend in manner such that each cable 44 has at least one bend 46 disposed therein along the length of the cable 44, between its two ends. These bends 46 are shown as generally right angle bends that divide the cable into two distinct lengths 48, 49, with one length 48 extending generally transverse to the mating direction of the first connectors 35 and the other length 49 extending generally parallel to the mating direction of the first connectors 35. The bends 46 provide a means by which the cables 44 can displace in response to the movement of the connector carrier 50. Additionally, the bends 46 relieve any stress which would normally occur at the cable wire terminations to the connector terminal tail portions.

Each of the terminal contact portions is received within a corresponding opening disposed in the mating connector 38. These openings contain their own terminal contact portions, such as pairs of contact beams or the like and making a reliable engagement with the mating connector terminals requires that a preselected force be applied for each first connector terminal 57. The total insertion force of the first connector 35 is calculated by multiplying the number of terminals of each first connector by the single insertion force ascribed to each terminal 57. That figure is then multiplied by the number of connectors to obtain the overall required insertion force for the cable module connector assembly, which is large.

In order to reduce the effort required to mate the connectors 35, 38 together and accommodate mating in confined spaces, an exterior actuator is provided which is operatively connected to a mechanism that not only translates one type of movement to another type of movement, but which also provides a large mechanical advantage to the operator. Turning to FIG. 6, the exterior actuator includes a lever 62 having a handle 63 attached to a body portion 64 which is pivotally held in place within a support block 65 by a pin 66. The lever body portion 64 has a motion slot 68 formed therein that receives the engagement end 69 of an elongated draw bar, or actuating bar 70, that extends transversely across the cable module 25 proximate to its front end 26. The draw bar end 69 has a post 71 captured in a slot 72 so that movement of the lever handle 63 induces movement of the draw bar 70. The draw bar 70 is captured by two support columns 75 which define a path for its movement. This movement is a reciprocating movement that occurs transverse to the mating direction of the cable module 25. The mating direction will also be considered as an “axial” direction of the module body.

The draw bar 70 includes one or more cam followers that take the form of raised, cylindrical posts 76 which are spaced apart from each other along the length of the draw bar 70. These posts 76 are positioned to contact cam surfaces 77 that are formed on a slide housing 78. The cam surfaces 77 take the form of cam slots 79, and as illustrated, the cam slots 79 are non-linear and may be arcuate, semi-circular or bifurcated as shown. The cam slots 79 illustrated may be best described as wide V-shaped slots, with each leg portion 80a, 80b of the “V” joined together at a junction 81 and extending therefrom at different angles so as to dictate a lesser or greater amount of movement in the slide housing 78 during operation. In the embodiment depicted, the angle of the first leg 80a is less than that of the other leg portion 80b so that the slide housing 78 is slowly moved forward with respect to the cable module 25 at first so that the first connectors 35 may be aligned properly with the mating connectors 38, and then the slide housing 78 moves forward at a faster rate so as to fully engage the first connectors 35 with the mating connectors 38.

FIG. 1 illustrates the cable module 25 oriented in the proper insertion position, with the first connectors 35 at its front end 26 and its second connectors 37 along the right side edge 28 thereof. In this orientation, the draw bar 70 is disposed and captured along the bottom plate 43 of the module 25 and this is shown best in FIG. 3B which is a perspective view of the cable module 25 inverted, i.e., with the base plate 43 shown up in the drawing. The draw bar 70 is captured in two slots that are formed in the end support blocks 75. The first connectors 35 are arranged in side-by-side order and are held within the carrier 50.

The first connectors 35 are terminated to the ends of selected wires of the cables and this termination may be made by welding, soldering or any suitable means. The connector carrier 50 and its associated array of first connectors 35 are held in place within the slide housing 78 that is cam actuated. The slide housing has a wide bracket portion 83 and a small clamp portion 81. These two portions 83, 81 are held together such as be screws or bolts. The bracket 83 has two enlarged body portions 86 on its opposing sides and these body portions 86 include a pair of bores 87 that receive guide rails 89 that project forwardly from the module front end 26 and which serve to guide the forward and return movement of the first connectors 35.

The bracket 83, as mentioned above, has two cam slots 79 disposed therein and the bracket 83 is placed over the draw bar 70 so that the cam follower posts 76 are received in the cam slots 79 and the bracket bores 87 engage the guide rails 89. In this manner, the slide housing 78 is captured in place at the front end 26 of the cable module 25 and is guided in its movement in the depth directions, namely forward and backward relative to the cable module front end 26. FIGS. 5A-5B show the manner in which the slide housing 78 is advanced and returned in reaction to movement of the exterior actuator lever. Additionally, a pair of alignment rods 95 may be provide that extend forwardly of the first connectors 35. The rods 95 are received in corresponding guide holes 96 formed in retainers that hold the opposing connectors 38 in place on the mother board (FIG. 9). These two Figures also illustrate another embodiment of a lever actuator 90 which includes a body portion 91 and a handle 92 projecting therefrom. The lever body portion 91 is pivotally connected to a connecting link 93 which in turn is pivotally connected to the actuating end 60 of the draw bar 70.

The flexible nature of the cables permits the first connectors to be easily moved in and out of engagement with the mating connectors. The placement of the bends in the cables within the module, separates each cable into two distinct horizontal extents that are transverse to each other. The offset in each cable provides a certain amount of “play” with the cable so that it can move integrally with the first connectors to which it is terminated.

FIGS. 10-12D illustrate another embodiment of an actuating assembly 100 that may be used with cable modules 25 of the Present Disclosure. In this embodiment, the first connectors 35 are also held in place in an array within the connector carrier 50, which is held in a slide housing 78. The carrier 50 (or the two shown in FIG. 10) is formed from top and bottom halves 52, 51 and when the two halves are engaged together, a pair of carrier locating ribs 53 are defined on each side of the carrier 50. These ribs 53 extend vertically as shown in the Figures and are received within corresponding slots 85 formed in the interior surfaces of the slide housing 78. As illustrated in FIG. 11A, a slight clearance is provided between the side edges 97 of the carrier locating ribs 53 and the interior wall 98 of the slide housing slot 85. This provides a preselected vertical clearance on the sides of the connector carrier 50 when held within the slide housing 78. Similarly, the bottom of the carrier locating ribs 53 project slightly past the bottom face of the carrier 50 to provide a horizontal clearance along the top and bottom of the connector carrier 50. In this manner, the first connectors 35 are mounted in the slide housing 78 so that they float therein in both the X (horizontal) and Y (vertical) directions. The connectors are fixed in the Z (depth) direction within the slide housing. However, the actuating mechanism permits the connectors to be advanced and returned as a unit in the Z direction.

FIGS. 12A-D illustrate the manner of operation of the hand crank actuating mechanism 104 of this embodiment. A chassis member 105 is provided and is mounted to the front end 26 of the cable module 25. This chassis member 105 has two support blocks 106 formed at its sides, each of which includes a cylindrical bore 107, the bores supporting an actuating shaft 108 that extends therethrough and transversely across and above the cable module 25. The chassis member further includes a hollow nest portion 109. A linkage 110 is provided and is disposed in a parallel fashion on the actuating shaft 108 proximate to and interior of the support blocks 106. Two hubs 112 are supported on the actuating shaft 108 and each hub 112 has a pair of first links 113 spaced apart from each other and which extend out from the hub 112 where they join a second link 114 disposed between them. The second link 114 is held between the first links 113 by way of a pin 115, or other suitable connection which permits rotational movement of the second link 114.

The second links 114 have a generally non-linear configuration that takes the form of what may best be described as a wide V-shape inasmuch as the second link 114 has two distinct leg portions 118a, 118b which are joined together at a junction 119. The general configuration of these second 114 links is similar to that of the cam follower slots 79 of the first embodiment. As seen in FIGS. 12C-D, the second link first leg portion 118a is shorter in length that the second leg portion 118b. The far ends of the second links 114 are attached to the slide housing 102 and the slide housing sits within the chassis nest portions 109 and on the guide rails 89. The chassis nest portion 109 and guide rails 89 serve to retain the slide housing 102 in a particular orientation with respect to the cable module 25 and guide it in mating and disengaging movement.

A hand crank 120 is provided and is attached to the far end 69 of the actuating shaft. Turning the hand crank 120, as shown in FIGS. 12A-B will extend the second links 114 to their full length away from the shaft, thereby causing the slide housing 102 to move forward and advance the connectors 35 in the carrier 50. The linkage 110 reduces the large insertion force to one that is manageable for a tightly confined space in which cable modules 25 of the Present Disclosure are used.

While a preferred embodiment of the Present Disclosure is shown and described, it is envisioned that those skilled in the art may devise various modifications without departing from the spirit and scope of the foregoing Description and the appended Claims.

What is claimed is:

1. A cable module for interconnecting a first circuit board with a plurality of second circuit boards, the first and second circuit board being angularly offset from each other, the module assembly, comprising:
a module body including front and rear ends and side edges interconnecting the front and rear ends together, the module body further including a base and a cover spaced apart from each other to define an interior space therebetween;
a set of first connectors disposed in an array extending along the module front end, and a set of second connector disposed in an array extending along one of the module side edges, each of the first and second connectors including an insulative connector housing supporting a plurality of conductive terminals therein, each terminal having a tail portion extending toward the module interior space, and a contact portion extending away from the module interior space;
a plurality of flexible cables disposed in the module body interior space, each of the cables having first and second ends, the cables including a plurality of wires extending therein between the cable first and second ends, the wires being terminated to the first and second connector terminal tail portions respectively near the cable first and second ends, the cables including at least one bend disposed therein between the cable first and second ends;
the first connectors being operatively connected, as a set, to the cable module by way of a movable mechanism which permits them to be selectively advanced in and out of engagement with a set of opposing mating connectors; and
an actuator exterior of the cable module for actuating the moveable mechanism.

2. The cable module of claim 1, further including a connector carrier that holds the first connectors together in alignment as a unit.

3. The cable module of claim 2, wherein the connector carrier includes first engagement members and the first connectors include second engagement members, the first and second engagement members engaging each other to hold the first connectors in place within the connector carrier.

4. The cable module of claim 2, wherein the moveable mechanism includes a slide housing supported by the cable module, the slide housing supporting the connector carrier in a manner such that the connector carrier is capable of limited horizontal and vertical movement within the slide housing, the slide housing having at least one cam surface disposed thereon, and the actuator including at least one cam follower that is maintained in contact with the slide housing one cam surface.

5. The cable module of claim 4, wherein the cable module further includes a pair of guide rails projecting forwardly from the module front end, the guide rails supporting the slide housing in horizontal between first and second operative positions.

6. The cable module of claim 5, wherein in the first operative position, the slide housing is disposed proximate the cable module front end and in the second operative position the slide housing is spaced away from the cable module front end.

7. The cable module of claim 4, wherein the slide housing further includes at least one guide pin extending forwardly of the connector carrier for engaging connectors disposed on the first circuit board in opposition to the first connectors.

8. The cable module of claim 7, wherein the linkage includes a hub fixed on the actuating shaft, a first link extending out from the hub, and a second link pivotally connected at opposite ends thereof to the first link and the slide housing.

9. The cable module of claim 4, wherein the slide housing includes two cam surfaces and the actuator includes two cam followers, each in contact with one of the two cam surfaces.

10. The cable module of claim 9, further including an actuating bar slidably mounted to the cable module, the actuating bar extending transversely along the cable module, and wherein the cam followers are disposed on the actuating bar such that linear movement of the actuating bar in a first direction induces a movement of the first connectors in a second direction, transverse to the first direction.

11. The cable module of claim 9, further including, wherein the slide housing cam surfaces include cam profile slots and the cam followers includes two raised engagement posts, each engagement post being captured within a single cam profile slot.

12. The cable module of claim 11, wherein the cam profile slots have a non-linear configuration, each of the cam profile slots having two leg portions that are joined together at a junction, the two leg portions extending from the union at different angles thereto.

13. The cable module of claim 1, wherein the cables extend in the interior space in two different directions, and the cables include bends which separates the two different directions.

14. The cable module of claim 1, further including an actuating shaft operatively connected to the actuator, the actuating shaft extending transversely along the cable module front end, and a linkage pivotally connecting the actuating shaft to the slide housing.

15. A cable module for interconnecting a first circuit board with a plurality of second circuit boards, the first and second circuit board being angularly offset from each other, the module assembly, comprising:
a module body having two ends and two sides, the module body supporting at one end, a plurality of first connectors and at one side, a plurality of second connectors, the connectors having conductive terminals supported in an array in associated connector housings;
a plurality of cables disposed in the module body, the cables providing electrical connections between the first and second connectors, the cables further being capable of selective displacement between opposing ends of the cables;
a slide housing slidably attached to the cable module so that it is capable of guided movement in a first direction between first and second operative positions, the slide housing including a connector carrier holding the first connectors together in an array; and
an actuator exterior of the cable module for moving the slide housing actuating the moveable mechanism.

16. The cable module of claim 15, wherein the actuator includes an actuating bar extending transversely with respect to the module body, and the actuating bar further includes a cam follower which engages a cam surface of the slide housing, whereby movement of the actuating bar in a transverse direction with respect to the module body imparts movement to the slide housing in an axial direction with respect to the module body.

17. The cable module of claim 15, wherein the connector carrier is supported in the slide housing in a floating manner so that the connector carrier is capable of limited horizontal and vertical movement.

18. The cable module of claim 15, wherein the slide housing include a plate with at least one cam slot formed therein and the actuator includes an actuating bar with at least one cam follower disposed thereon, the cam follower being captured within the cam slot.

19. The cable module of claim 15, wherein the module body includes a chassis member with a hollow nest and the slide housing is slidably supported within the chassis member nest.

20. The cable module of claim 19, wherein the actuator include a crank attached to an actuating shaft, the actuating shaft extending transversely with respect to the module body, the actuating shaft including a linkage that interconnects the actuating shaft and the slide housing together, whereby rotation of the crank imparts movement to the slide housing in an axial direction with respect to the module body.
